(19) United States
(12) Patent Application Publication
(10) Pub. No.: US 2012/0281064 A1
(43) Pub. Date: Nov. 8, 2012

(54) Universal 3D Enabler and Recorder

(75) Inventors: Ray Hamilton Holloway, Spokane, WA (US); Christopher John Borg, Palm Coast, FL (US); Clifton Bradley Parker, Duluth, GA (US); Clifton Earl Parker, Suwanee, GA (US)

(73) Assignees: Citynet LLC, Suwanee, GA (US); 3D Surgical Solutions, Marietta, GA (US)

(21) Appl. No.: 13/100,279

(22) Filed: May 3, 2011

(51) Int. Cl. H04N 13/00

(52) U.S. Cl. 348/43; 348/E13.003; 901/47

(57) ABSTRACT

A method and apparatus to provide simplified control over image configuration from virtually any capture device and allows that image to be recorded and/or projected or displayed on any monitor is disclosed. This universality enables general ease of use, and uncouples the capture device from expensive system support, thus providing a method to more efficiently utilize resources.

### TECHNICAL FIELD

These claimed embodiments relate to a method for receiving 3D video and enabling display of such video on a 3D monitor, and more particularly to recording 3D images received from camera attached to a surgical instrument and adjusting the 3D images in real time for display on a 3D monitor.

### BACKGROUND OF THE INVENTION

A method and apparatus for enabling and recording of 3D video images is disclosed.

In order to utilize 3D images it is necessary to capture the images, and transmit them. Capture technologies utilize various means to obtain the duel images necessary for 3D mode of display (over/under, side-by-side, or interlaced), and the type of 3D display (passive, active, or autostereoscopic). These varying technologies present control issues that typically require dedicated hardware and software systems capable of providing control functions to capture the images. Similar control issues are required on the display side of the transmission spectrum.

In prior systems, display monitors typically are designed to utilize a finite set of image specifications, and control over the monitor input is limited to preset parameters. In addition, if recording is to be utilized, the sequence of control must be properly taken into consideration.

The technical issues to operate these systems require advance skill, knowledge and training for routine utilization. A drawback of these systems is that this advanced knowledge requirement, as well as the previously mentioned dedicated system requirement, limits the availability and utilization of 3D technology.

### SUMMARY OF THE INVENTION

In one implementation a method is disclosed that receives left images of an object, e.g. a part of the body, captured from a first perspective and right images of the object captured from a second perspective. The left images and right images are joined to form a video containing three dimensional (3D) conjoined images. The conjoined images are stored in digital form on a non-transitory storage medium. A convergence is applied to the stored conjoined images to create a displayable 3D image, and the displayable 3D images are transmitted to one or more 3D display devices in digital form.

In another implementation, a system is disclosed including a receiver to receive left images of an object captured from a first perspective and right images of the object captured from a second perspective. A conjoiner module is used to join the left images and right images to form a video containing three dimensional (3D) conjoined images. The video of the conjoined images are stored on non-transitory storage medium in digital form. A converger module applies a predetermined level of convergence to the stored conjoined images to create a displayable 3D image. A transmitter adapts and transmits the displayable 3D images to one or more 3D display devices in digital form.

In addition, a computer readable storage medium comprising instructions is disclosed. The instructions when executed by a processor include receiving left images of an object captured from a first perspective and right images of the object captured from a second perspective, joining the left images and right images to form a video containing three dimensional (3D) conjoined images, storing the video containing the conjoined images in digital form on a non-transitory storage medium, applying a predetermined convergence to the stored video to create a displayable video of the 3D images, and transmit the displayable video to a 3D display device in digital form.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a Universal 3D Video Enabler and Recorder system;

FIG. 2 is a simplified schematic diagram of a exemplary mobile computing device used in the Universal 3D Video Enabler and Recorder system;

FIG. 3 is a flow chart of a process for capturing and recording 3D video images used in the Universal 3D Video Enabler and Recorder system; and

FIG. 4 is an exemplary of an input/output device used in used in the Universal 3D Video Enabler and Recorder system.

### DETAILED DESCRIPTION

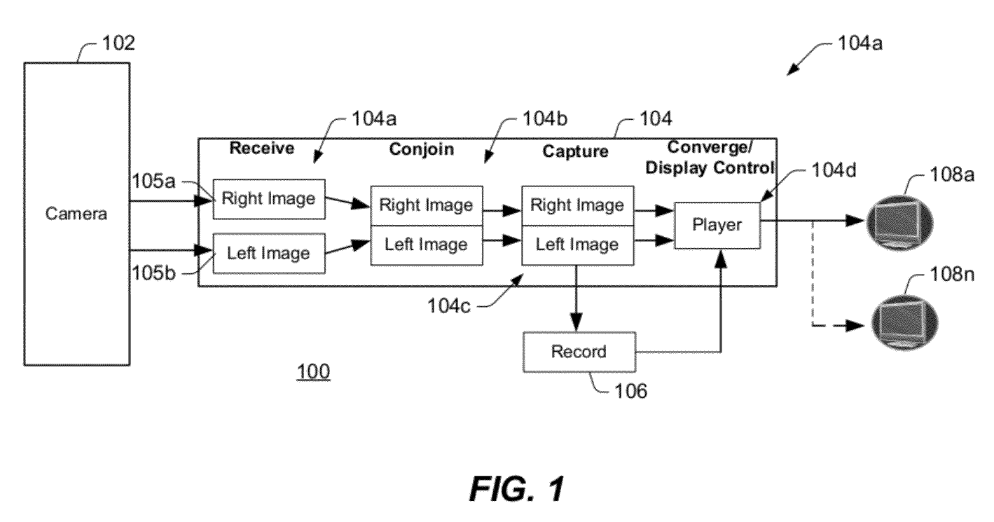

Referring to FIG. 1 there is shown a system 100 for capturing 3D images, and adapting the images for display on a 3D monitor. The system includes a surgical camera device 102 which captures 3D images. The camera device 102 is coupled via a computer device 104 to monitors 108a-108n. Examples of camera device 102, include, but are not limited to, an endoscopic surgical device, a surgical robot (e.g. da Vinci surgical robot made by Intuitive Surgical, Inc., models: da Vinci (standard), da Vinci S, or da Vinci Si h) or a 3D camera. In one implementation the camera device 102 is positioned on the end of a surgical endoscope. Device 104 may be connected to the camera via an HDMI cable or via any high speed video connector that is operative for passing high speed signals.

Device 104 has a left channel input port 105a and right channel input port 105b receiving left channel images and right channel images respectively. Using separate channels allows capturing a different perspective of an object taken by camera device 102.

Device 104 receives, using receiver module 104a, the left image via input port 105a and right image on an input port 105b. Device 104, also uses receiver module 104a, to capture the received images and store the received images in the device's memory. Device 104, using conjoiner module 104b, joins the left and right images to create a conjoined image using conventionally known joining techniques. Device 104, using capture module 104c captures the conjoined images as captured 3D video images. The captured 3D video images may be encoded in a compressed format (such as H.264, or mpeg format) and recorded on a digital storage device, such as external storage device 106. In one implementation storage device 106 may be a memory internal to device 104. The captured 3D video images may be fed to a player 104d that can decode and play the captured and/or recorded video. Such a player may be adapted to allow the capture 3d video images to be viewed through any 2D or 3D TV or monitor. Player 104d may include parameters that are used to convert the 3d video images to the format necessary to enable the 3d video images to be viewed on 3D monitors from different manufactures or different 3D image modes. In one implementation, the convergence of 3D video from player 104d can be adjusted by the user of device 104 using standard convergence adjustment techniques. More details of adjusting the convergence of player 104d are described herein. Further the 3D video output of the player 104d may be adapted to be played on a 3D video monitor 108a. Player 104 then feeds the adapted 3D video to one or more 3D video monitors 108a-108n. Exemplary monitors include Manufacturers of 3D Display monitors (passive, active and autostereoscopic types) including but not limited to, Panasonic Viera, Samsung, LG, Hyundai, and Sony.

### Example 3D Player and Recorder Device Architecture

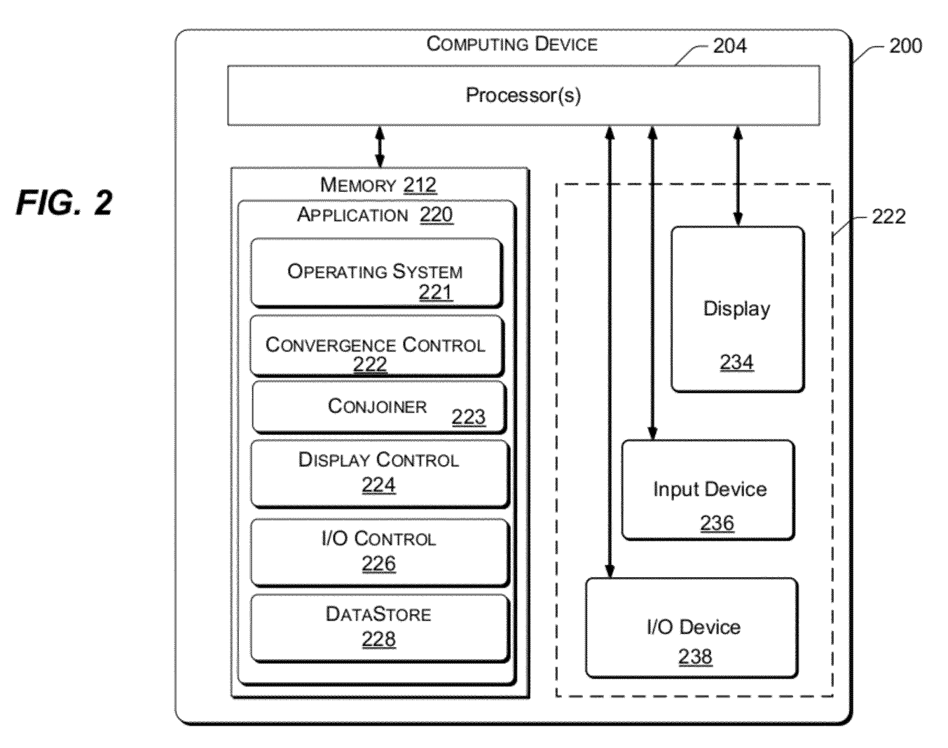

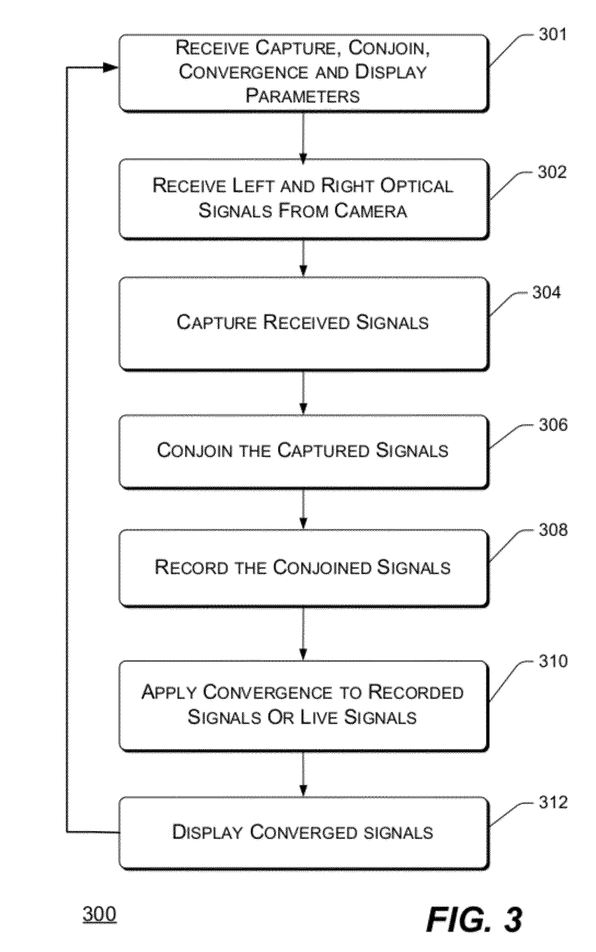

In FIG. 2 there are illustrated selected modules in computing device 200 (Computing Device 104 of FIG. 1) using process 300 shown in FIG. 3. Hosting device 200 includes a processing device 204, memory 212, and hardware 222. Processing device 204 may include one or more a microprocessors, microcontrollers or any such devices for accessing memory 212 or hardware 222. Processing device 204 has processing capabilities and memory suitable to store and execute computer-executable instructions.

Processing device 204 executes instruction stored in memory 212, and in response thereto, processes signals from hardware 222. Hardware 222 may include a display 234, and input device 236 and an I/O device 236. I/O device 238 may include a network and communication circuitry that has a transceiver (including a transmitter and receiver) for communicating with a network, and external monitors or the camera device. I/O device 238 may transmit displayable 3D images to a 3D display device in digital form. Input device 236 receives inputs from a user of the host computing device 200 and may include a keyboard, mouse, track pad, microphone, audio input device, video input device, or touch screen display. Display device 234 may include an LED, LCD, CRT or any type of monitor.

Memory 212 may be a non-transitory storage medium. Memory 212 may include volatile and nonvolatile memory, removable and non-removable media implemented in any method or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 212 of device 200 may include an operating system 221, a converger control module 222, a conjoiner module 223, a display control module 224, an Input/Output control module 226 and a library of other applications such as a data store 228. Operating system 214 may be used by application 220 to operate device 200. The operating system 214 may include drivers for device 200 to communicate with I/O device 226. Data Store 228 may include preconfigured parameters (or set by the user before or after initial operation) such as surgical camera brand, model and respective optical signal parameters; display brand, model and respective optical signal parameters; and convergence parameters.

Illustrated in FIG. 3, is a process 300 for transforming 3D images received from a surgical camera, e.g. camera 102 to video for display on a 3D monitor. The exemplary process in FIG. 3 is illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 2, although it may be implemented in other system architectures.

Referring to FIG. 3, a process 300 is shown for transforming 3D image signals using the computing device and modules shown in FIG. 2. In the process, the computing device 200 (FIG. 2) in block 301, receives parameters relating to capture, conjoining of the 3D image signal, 3D convergence and/or a 3D monitor or display device. Such parameters may be stored in a table within data store 228.

In one implementation these parameters are selected by a user using an I/O device 236. In such an implementation, the user is provided a list of surgical camera devices, and 3D display monitors stored in the table within data store 228. The user then selects the surgical camera device and 3D display monitor. Predetermined configurations for the camera device and 3D display monitor may be stored in the data store and retrieved by the computing device when these devices are selected. In another implementation, the configurations may be provided from an external source and stored in data store 228.

In another implementation, different convergent parameters may be stored in the data store 228. The user may then select the different convergent parameters using the I/O device. An indication of the selection of the user may be stored in the table with the convergent parameters within data store 228. In response to the selection, the corresponding parameters (also stored in data store 228) relating to the convergence of the video that is selected by the user may be retrieved.

In block 302, the computing device receives signals containing information corresponding 1) to left images of an object captured from a first perspective by the camera and 2) to right images of the object captured from a second perspective by the camera 102.

In block 304, the received signals corresponding to the left and right images are captured in the memory of the computing device. In block 306, the left and right images are joined together into a single frame to form a conjoined 3D image. In one implementation the left images are stored as a left image layer and the right images are stored as a right image layer in the same frame. The left and right layers are stored in the same frame on top of each other, to form the 3D conjoined image.

In block 306, the conjoined 3D images are stored in digital form as a live image in memory of the computing device. In one implementation, in block 308 a copy of the 3D images are encoded and stored as a recorded image in an external memory device.

In block 310, the prestored convergence parameters corresponding to the user selected convergence is retrieved from table in the datastore 228. The convergence parameters are applied to the recorded image or the live image to change the convergence of the image using generally known techniques. The convergence parameters can be applied and adjusted by the user in real time while simultaneously displaying the image (in block 312).

In block 312, the image adjusted using the convergence parameters is further formatted to reflect the selected 3D display device. The formatted image is transmitted in digital form to one or more 3D capable display devices for viewing. After executing block 312, the computing device 200 jumps to block 301, and receives parameters.

### Exemplary I/O Panel

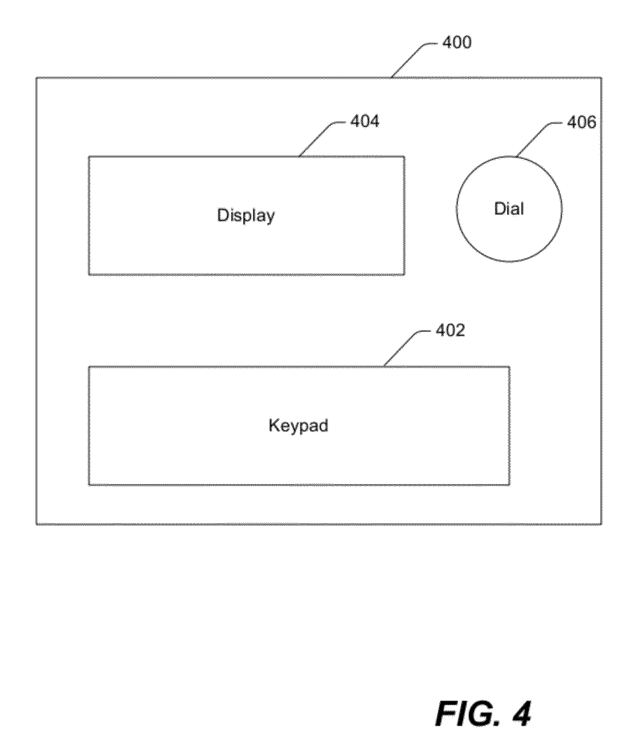

Referring to FIG. 4, in one implementation an exemplary I/O device 400 is used to enable the user to select the 3D monitor, the type of camera and the convergence parameters. In one implementation, I/O device includes a keypad 402 and display 404 and a rotating dial 406. The user enters information on the keypad related to the camera and the 3D display device. The rotating dial can be used to adjust the convergence of the image as discussed in connection with block 310 of FIG. 3. Although one type of I/O device is shown, other types of I/O devices may easily be substituted for the one shown I/O device. Examples of other types of I/O devices include a keyboard, a touch pad display and a wireless remote controller.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A method comprising:
receiving a plurality of left images of an object captured from a first perspective and a plurality of right images of the object captured from a second perspective;
joining the left images and right images to form a digital video of three dimensional (3D) conjoined images;
storing the conjoined images in digital form on a non-transitory storage medium;
applying a predetermined convergence to the stored conjoined images to create a displayable 3D image; and
transmitting the displayable 3D images to a 3D display device in digital form.

2. The method as recited in claim 1, further comprising:
storing predetermined parameters regarding a plurality of different 3D display devices in a memory;
receiving an indication selecting one of the plurality of 3D display devices;
retrieving the predetermined parameters for the selected one of the plurality of 3D display devices from the memory and modifying the displayable 3D image based on the selected 3D display device; and
wherein transmitting the displayable 3D image to the 3D display device comprises transmitting the modified displayable 3D image to the 3D display device.

3. The method as recited in claim 1 wherein receiving a left image of an object captured from a first perspective and a right image of the object captured from a second perspective comprises:
receiving a left image and the right image from a camera positioned on a surgical endoscope.

4. The method as recited in claim 1 wherein conjoining the left images and the right images to form the 3D conjoined images comprises:
laying the each of the plurality of left images over each of the plurality of right images, respectively, and inserting each of the layered left images and each of the layered right images in a video frame to form the 3D conjoined images.

5. The method as recited in claim 1 wherein applying a predetermined convergence to the stored conjoined images to create a displayable 3D image comprises:
receiving an input signal from an I/O device indicating parameters regarding the predetermined convergence; and
applying the indicated predetermined convergence parameters to the stored conjoined images.

6. The method as recited in claim 5 further comprising:
transmitting the displayable 3D images to the 3D display device in digital form while simultaneously applying the indicated predetermined convergence parameters to the displayable 3D images.

7. The method as recited in claim 1 wherein transmitting the displayable 3D images to a 3D display device in digital form comprises:
retrieving from a storage device and pre-stored parameters for the 3D display;
modifying the displayable 3D images in accordance with the retrieved parameters; and
transmitting the modified 3D images to a computing device.

8. The method as recited in claim 1 further comprising transmitting the displayable 3D images in digital form to a second 3D display device requiring a different video format.

9. A system comprising:
a receiver to receive a plurality of left images of an object captured from a first perspective and a plurality of right images of the object captured from a second perspective;
a conjoiner to conjoiner the left images and right images to form a video of three dimensional (3D) conjoined images;
a non-transitory storage medium to store the conjoined images in digital form;
a converger to apply a predetermined convergence to the stored conjoined images to create a displayable 3D image; and
a transmitter to transmit the displayable 3D images to a 3D display device in digital form.

9. The system as recited in claim 8 wherein the memory includes:
predetermined parameters regarding a plurality of different 3D display devices; and
an indication of a selection of one of the plurality of 3D display devices;
wherein the system comprises means for retrieving the predetermined parameters for the selected one of the plurality of 3D display devices from the memory and modifying the displayable 3D image based on the selected 3D display device; and
wherein the transmitter is operable to transmit the modified displayable 3D image to the 3D display device.

10. The system as recited in claim 8 wherein the receiver receives a left image of an object captured from the first perspective from a surgical robot and the right image of the object captured from a second perspective from the surgical robot.

11. The system as recited in claim 8 wherein the conjoiner is operable to overlay each of the plurality of left images onto each of the plurality of right images, respectively, to form the 3D conjoined images.

12. The system as recited in claim 8 wherein the converger is operable to receive an input signal from an I/O device indicating parameters regarding the predetermined convergence, and apply the indicated predetermined convergence parameters to the stored conjoined images.

13. The system as recited in claim 8 wherein the transmitter is operable to transmit the displayable 3D images to the 3D display device in digital form while simultaneously applying the indicated predetermined convergence parameters to the displayable 3D images.

14. The system as recited in claim 8 wherein the transmitter is operable to retrieving from a storage device pre-stored parameters for the 3D display, modify the displayable 3D images in accordance with the retrieved parameters, and transmit the modified 3D images to a computing device.

15. A computer readable storage medium comprising instructions which when executed by a processor comprises:
receive a plurality of left images of an object captured from a first perspective and a plurality of right images of the object captured from a second perspective;
conjoin the left images and right images to form a video of three dimensional (3D) conjoined images;
store the conjoined images in digital form on a non-transitory storage medium;
apply a predetermined convergence to the stored conjoined images to create a displayable 3D image; and
transmit the displayable 3D images to a 3D display device in digital form.

16. The computer readable storage medium as recited in claim 15, wherein the instructions which when executed by a processor further comprises:
storing predetermined parameters regarding a plurality of different 3D display devices in a memory;
receiving an indication selecting one of the plurality of 3D display devices;
retrieving the predetermined parameters for the selected one of the plurality of 3D display devices from the memory and modifying the displayable 3D image based on the selected 3D display device; and
wherein transmitting the displayable 3D image to the 3D display device comprises transmitting the modified displayable 3D image to the 3D display device.
